(19) United States
(12) Patent Application Publication
(10) Pub. No.: US 2006/0029317 A1
(43) Pub. Date: Feb. 9, 2006

(54) Bearing structure

(76) Inventor: Toshihiro Yamamoto, Osaka (JP)

Correspondence Address: ATTY;GREENBLUM & BERNSTEIN, P.L.C., 1950 Roland Clarke Place, Reston, VA, 20191, US

(21) Appl. No.: 10/952,740

(22) Filed: Sep. 30, 2004

(30) Foreign Application Priority Data
Aug. 4, 2004 (JP) 2004-228597

(51) Int. Cl. F16C 13/00

(52) U.S. Cl. 384/545

(57) ABSTRACT

The present invention is intended to provide a bearing structure in which a reference side bearing portion and an aligning side bearing portion can be installed with axial centers nearly aligned to each other even when the axial center of rotary shaft is inclined, and it is possible to obtain smooth and stable rotation for a long consecutive period of time. Left cup 7 of the bearing structure is axially moved so that ball 9a . . . held on holding ring 9b of aligning side bearing portion 9 is abutted on left-hand flange 4a of crank shaft 4, and also, holding ring 9b is spherically adjusted along the spherical surface of left cup 7, and the bearing center of all ball 9a . . . held on holding ring 9b is automatically aligned so as to be nearly aligned to the axial canter of crank shaft 4 which bears on reference side bearing portion 8, thereby displaying a bearing function while assuring smooth and stable rotation.

### BACKGROUND OF THE INVENTION

1. Field of the Invention

The present invention relates to a bearing structure used for bearing, for example, a crank shaft, hub shaft, and pedal shaft of a bicycle or a rotary shaft and the like of a machine or a mechanism.

2. Description of the Prior Art

Conventionally, as a bearing structure as mentioned above, for example, there is a bearing structure (Japanese Patent Laid-Open Application No.: 2003-300494) of patent document 1 wherein a right cup and a left cup are fixed at either end of a hanger lag of the hanger section of a bicycle, and bearings built in the right and left cups serve to rotatably bear a crank shaft.

However, in case the installation accuracy of the cup fixed on the hanger lag is low, the rotational center of the bearing built in the cup will become inclined against the axial center of the crankshaft, causing the rotational resistance and contact resistance given to some of balls of the bearing to be increased, thereby worsening the rotation of the bearing. Also, great noise is generated during rotation, and parts are liable to loosen due to vibration or shocks generated during rotation of the crank shaft, which may invite occurrence of trouble, damage, accidents, injuries and the like.

Also, in the case of a bearing structure which directly bears a crank shaft with a plurality of balls, if it is set up with the bearing center of the whole ball held in the cup inclined against the axial center of the crankshaft, the rotational stress of the crank shaft is directly given to some of the balls, then the balls are liable to be damaged or scratched, and therefore, it is difficult to obtain smooth and stable rotation for a long period of time. Also, when a pair of right and left bearings and crank shafts are installed in the form of a unit, it will result in increase of the number of parts and man-hour required for installation of the bearing structure, requiring more work and time for installation and also causing the manufacturing cost to become higher.

### SUMMARY OF THE INVENTION

The main object of the present invention is to provide a bearing structure which can be installed with a reference side bearing portion and an aligning side bearing portion nearly axially aligned to each other even when the axial center of rotary shaft is inclined, and may continuously assure smooth and stable rotation for a long period of time.

Another object of the present invention will be shown in the description of the following embodiment.

### BRIEF DESCRIPTION OF THE DRAWINGS

FIG. 1 is a side view showing the hanger section of a bicycle.

FIG. 2 is a perspective view showing an exploded state of a hanger section.

FIG. 3 is a perspective view showing an exploded state of an aligning side bearing portion.

FIG. 4 is an enlarged sectional view showing a bearing structure of an aligning side bearing portion.

FIG. 5 is a sectional view showing a bearing structure with a bearing built in an aligning side bearing portion.

FIG. 6 is a perspective view showing a state of installation of a hanger section.

FIG. 7 is an enlarged sectional view showing an aligned state of aligning side bearing portion.

FIG. 8 is a sectional view showing a bearing structure which directly bears a crank shaft with balls.

FIG. 9 is an enlarged sectional view showing a bearing structure which bears hub shaft of hub section.

FIG. 10 is an enlarged sectional view showing a bearing structure which bears a handle shaft of a handle section.

### DESCRIPTION OF THE PREFERRED EMBODIMENT

The preferred embodiment of the present invention will be described in the following with reference to the drawings.

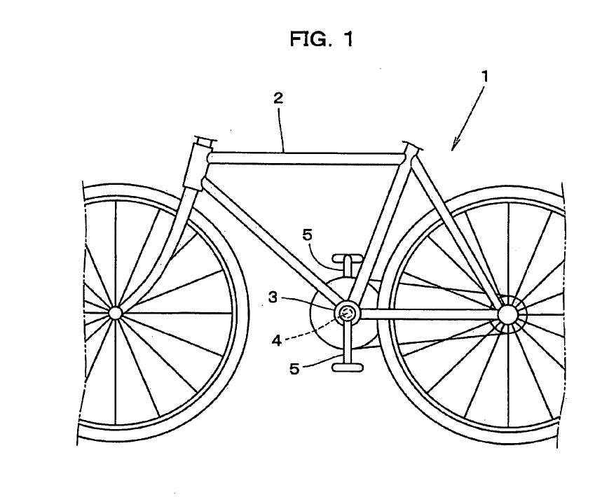

FIG. 1 shows a left side view of bicycle 1. Crank shaft 4 is adjustably inserted into hanger section 3 disposed at the lower center of frame body 2, and a pair of right and left crank arms 5, 5 are fixed at the right and left ends of crank shaft 4 projected at both ends of hanger section 3.

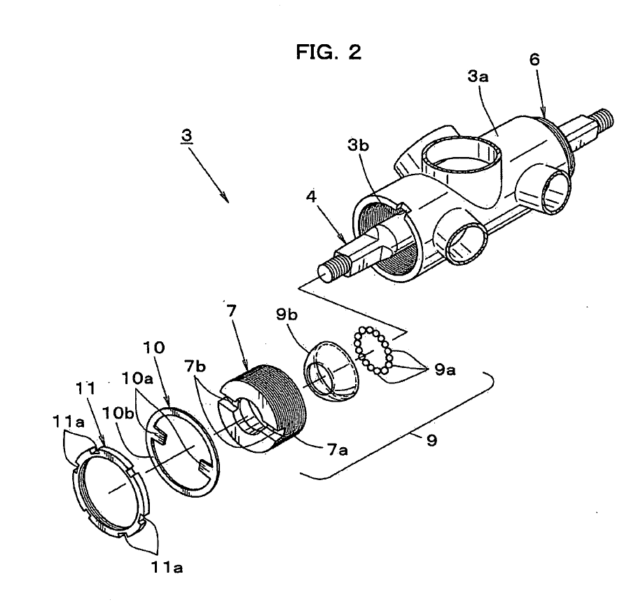

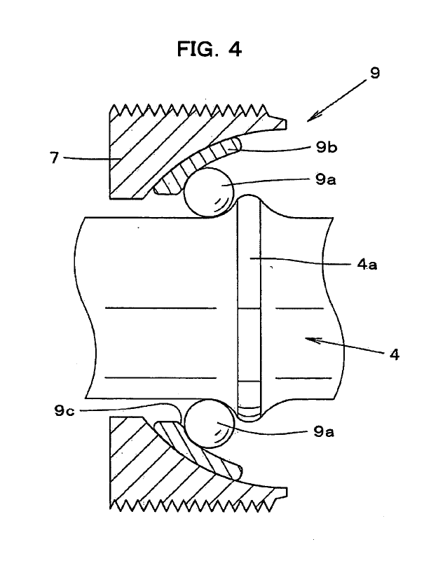

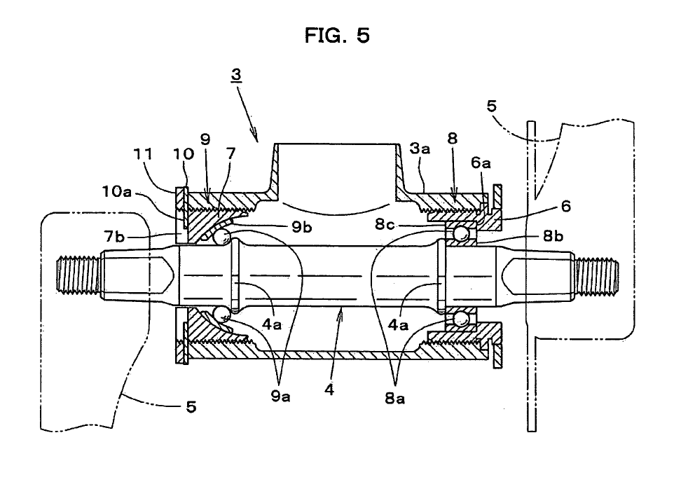

A bearing structure built in the hanger section 3 is, as shown in FIG. 2, FIG. 4 and FIG. 5, configured in that right cup 6 is screwed in the right-hand end of hanger lag 3a, and crank shaft 4 is inserted from the left-hand end of hanger lag 3a, and left cup 7 is screwed in the left-hand end of hanger lag 3a, and crank shaft 4 bears upon right-hand bearing portion 8 built in right cup 6 and left-hand bearing portion 9 built in left cup 7, and fastening nut 11 is screwed onto the left-hand end of lift cup 7 via washer 10.

The bearing portion 8 comprises a bearing which rotatably retains a plurality of balls 8a . . . between receiving ring 8b and receiving ring 8c, and receiving ring 8b fixed on the right-hand outer periphery of crank shaft 4 is abutted on flange 4a formed at the outer periphery, and receiving ring 8c fixed on the inner periphery of right cup 6 is abutted on shoulder 6a formed at the inner periphery of right cup 6, thereby adjustably bearing the right-hand end of crank shaft 4.

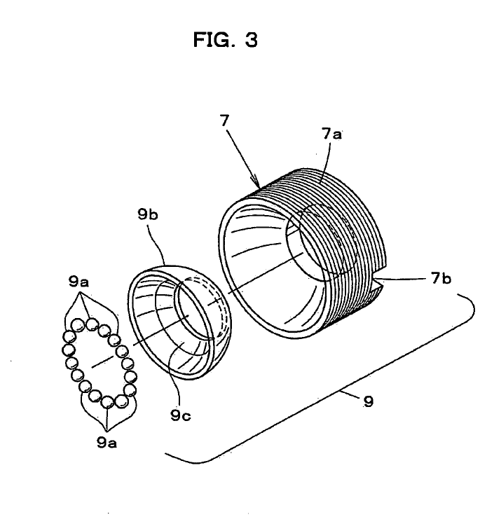

The bearing portion 9 is, as shown in FIG. 3 and FIG. 4, configured in that a plurality of balls 9a . . . are rotatably held between flange 4a formed at the left-hand outer periphery of crank shaft 4 and holding ring 9b having a generally bowl-like shape, and holding ring 9b is adjustably held at the inner periphery of left cup 7, thereby adjustably bearing the left-hand end of crank shaft 4.

Also, the inner periphery of left cup 7 and the outer periphery of holding ring 9b are formed into smooth and generally spherical shape with nearly a half radius around the axial center of crank shaft 4, and both left cup 7 and holding ring 9b are installed in such manner that they are adjustable in all directions around the axial center of crank shaft 4.

Further, the contact resistance and contact area generated at the opposing surfaces of left cup 7 and holding ring 9b are greater than the contact resistance and contact area generated at the outer periphery of ball 9a . . . , and in rotation of crank shaft 4, it is possible to prevent holding ring 9b from rotating in same direction or rotating together.

Also, the inner periphery of holding ring 9b that retains balls 9a . . . is formed into smooth and generally spherical shape with nearly a half radius around the axial center of crank shaft 4, and convex shoulder 9c formed at the end inner periphery (small-diameter or large-diameter side) of holding ring 9b is formed smaller in diameter than the spherical periphery that retains balls 9a . . . .

On the other hand, washer 10 fitted to the left-hand end of left cup 7 is formed in such thickness that it is possible to deform by tapping or bending at a proper position, and when it is fitted to thread portion 7a of left cup 7 projected at the left-hand end of hanger lag 3a, a plurality of (or one) stop lugs 10a . . . formed at the inner periphery edge of washer 10 are stopped in a plurality of (or one) stop grooves 7b . . . formed at the left-hand end of left cup 7. It is also possible to install without washer 10.

The stop groove 7b . . . has a depth equivalent to the total thickness of washer 10 and fastening nut 11, and the groove is formed at least deep enough to allow the turning operation of a jig, enabling the fitting of stop lug 10a of washer 10.

Also, projection 10c formed by deforming annular portion 10b of washer 10 so as to be projected rightward engages stop groove 3b formed at the left end of hanger lag 3a.

Fastening nut 11 fitted to the left end of left cup 7 next to the washer 10 is screwed onto thread 7a of left cup 7 at the left end of hanger lag 3a, and projection 10d formed by deforming annular portion 10b of washer 10 so as to be projected leftward engages a plurality of (or one) depressions 11a . . . formed at the outer periphery of fastening nut 11.

After that, as shown in FIG. 1, a pair of right and left crank arms 5, 5 are fixed on the right and left ends of crank shaft 4 projected at both ends of hanger lag 3a. Also, fitting a plastic or metallic cover to one end or both ends of hanger section 3, it is possible to prevent for example intrusion and sticking of foreign matter such as mud, water or the like.

The embodiment shown is configured as described above, and the method of adjustably bearing crank shaft 4 on hanger 3 of frame body 2 of bicycle 1 by using the bearing structure of the present invention will be described in the following.

First, as shown in FIG. 2, FIG. 3 and FIG. 5, right cup 6 is screwed onto the right-hand end of hanger lag 3a of hanger section 3, and crank shaft 4 is inserted from the left end of hanger lag 3a to bear the right-hand end of crank shaft 4 with bearing portion 8 built in right cup 6 so as to be positioned on the basis of bearing portion 8.

Next, left cup 7 is screwed onto the left-hand end of hanger lag 3a, and bearing portion 9 built in left cup 7 bears upon the left-hand end of crank shaft 4. In case crank shaft 4 and left cup 7 are axially aligned to each other because of the high installation accuracy of left cup 7, when left cup 7 is turned and tightened with a jig, all balls 9a . . . held by holding ring 9b are nearly uniformly abutted on left-hand flange 4a of crank shaft 4, and as shown in FIG. 4, it is possible to display a bearing function while assuring smooth and stable rotation.

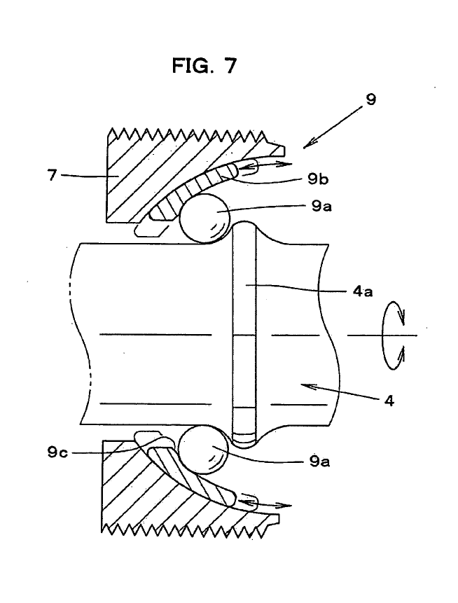

Also, as shown in FIG. 7, in case left cup 7 is inclined against the axial center of crank shaft 4 because of poor installation accuracy of left cup 7 screwed onto the left-hand end of hanger lag 3a, when left cup 7 is turned and tightened with a jig, some of balls 9a . . . held by holding ring 9b are first abutted on left-hand flange 4a of crank shaft 4.

Further, balls 9a . . . not abutted thereon are moved in the direction of abutting the left-hand flange 4a of crank shaft 4, and holding ring 9b is peripherally adjusted along the inner spherical surface of left cup 7, and the bearing center of all balls 9a . . . held by holding ring 9b of aligning side bearing portion 9 is automatically aligned so as to be nearly aligned to the axial center of crank shaft 4 which bears upon reference side bearing portion 8, and thereby, all balls 9a . . . held by holding ring 9b are nearly uniformly abutted on left-hand flange 4a of crank shaft 4.

Also, when balls 9a . . . held by holding ring 9b are abutted on left-hand flange 4a of crank shaft 4, balls 9a . . . not abutted thereon tend to move in the direction of lower resistance along the spherical surface of holding ring 9b, but balls 9a . . . abut the shoulder 9c of holding ring 9b, causing balls 9a . . . and holding ring 9b to rotate together, thereby enabling automatic alignment while keeping an optimum holding position.

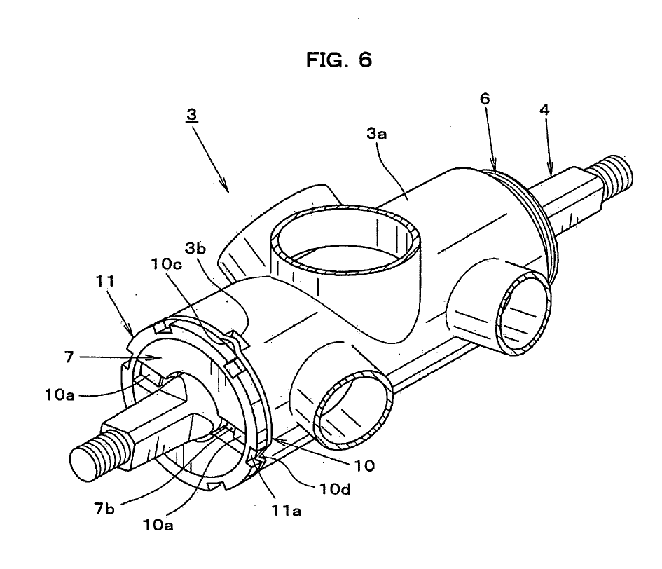

Next, stop lug 10a . . . of washer 10 fitted to thread 7a of left cup 7 projected at the left-hand end of hanger lag 3a is stopped in stop groove 7b . . . of left cup 7, and projection 10c formed by deforming annular portion 10b of washer 10 so as to be projected rightward is fitted in stop groove 3b of hanger lag 3a, and projection 10d formed by deforming annular portion 10b of washer 10 so as to be projected leftward is stopped in depression 11a . . . of fastening nut 11, thereby setting it up in a state shown in FIG. 6.

Thus, with left cup 7 turned and tightened, due to the stress generated when balls 9a . . . held by holding ring 9b are abutted on left-hand flange 4a of crank shaft 4, holding ring 9b is peripherally adjusted along the spherical surface of left cup 7, and aligning side bearing portion 9 is automatically aligned so as to be nearly aligned to the axial center of reference side bearing portion 8, and therefore, even when the axial center of crank shaft 4 is inclined with left cup 7 tightened, it can be set up so that reference side bearing portion 8 and aligning side bearing portion 9 are nearly axially alighted to each other, thereby improving the installation accuracy and bearing accuracy.

Also, during rotation of crank shaft 4, there is no fear of loosening or vibration, and all balls 9a . . . held by holding ring 9b are nearly uniformly abutted on left-hand flange 4a of crank shaft 4, and therefore, the rotational resistance given to crank shaft 4 is reduced, assuring smooth and stable rotation for a long consecutive period of time.

Further, since the rotation of crank shaft 4 is stabilized, the anti-loosening function of the bearing structure is not damaged, and no unbalanced load is given to the structure because the stress is diffused, and loosening trouble is hard to take place. Also, rotational noise is lessened, and troubles caused due to vibration, loosening, cracking, damage or the like, and missing of parts can be avoided.

Also, the number of parts of the bearing structure is less and the man-hour required for installation is greatly reduced as compared with the case of installing the crank shaft 4 and a pair of bearing portions 6, 7 in the form of a unit, and therefore, the installation work can be easily performed.

Also, the work and process for enhancing the installation accuracy of left cup 7 so as to make aligning unnecessary can be omitted, and it is possible to reduce the manufacturing cost.

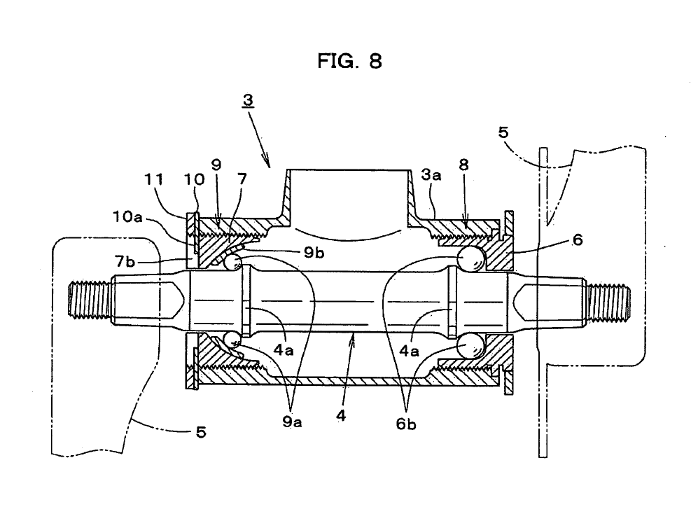

FIG. 8 shows another example of a bearing structure in which a plurality of balls 6b . . . are held by right-hand flange 4a of crank shaft 4 and right cup 6 instead of bearing portion 8 having a bearing shape. Since crank shaft 4 bears with a pair of right and left bearing portions 8, 9, it is possible to display an action and effect almost the same as in the above embodiment. The same component parts as in the above embodiment are given same reference numerals, and the detailed description is omitted.

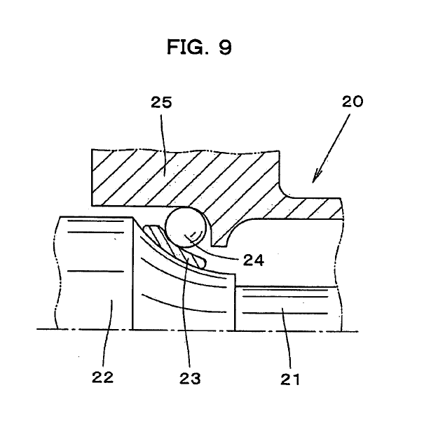

FIG. 9 shows other example of a bearing structure in which hub section 20 of frame body 2 of bicycle 1 adjustably bears hub shaft 21. Ball-push ring 22 fitted to the outer surface of hub shaft 21 is axially moved so that ball 24 . . . held by holding ring 23 is abutted on the inner surface of hub body 25, also adjusting the holding ring 23 along the outer spherical surface of ball-push ring 22, and the bearing center of all balls 24 held by holding ring 23 is automatically aligned so as to be nearly aligned to the axial center of hub shaft 21, and therefore, it is possible to display an action and effect almost the same as in the above embodiment. Also, it is preferable to install holding ring 23 on the inner periphery of hub body 25.

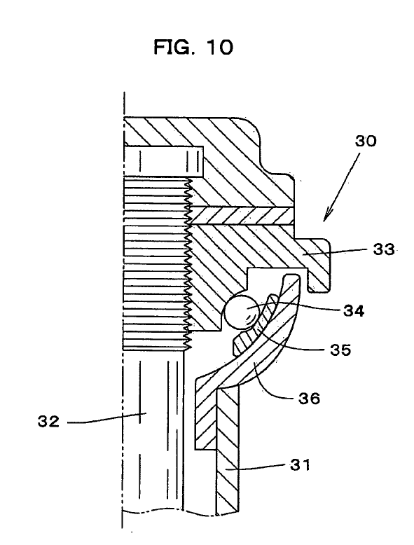

FIG. 10 shows other example of a bearing structure in which handle shaft 32 adjustably bears with head lag 31 of handle section 30 of bicycle 1. Upper ball-push ring 33 fitted to handle shaft 32 is axially moved, and also, holding ring 35 is adjusted along the inner spherical surface of upper cup 36 via ball 34 . . . , and therefore, it is possible to display an action and effect almost the same as in the above embodiment. Also, it is preferable to install the holding ring 35 on upper ball-push ring 33 or on either one of the lower cup and the lower ball-push ring.

In the configuration of the present invention and the above embodiment:
the cylindrical portion in the present invention corresponds to hanger section 3, hub section 20, and handle section 30, and
similarly,
the rotary shaft corresponds to crank shaft 4, hub shaft 21, and handle shaft 32, the movable member corresponds to left cup 7, ball-push ring 22, and upper ball-push ring 33, while the holding member corresponds to holding ring 9b, 23, 35, but the present invention is not limited only to the configuration of the above embodiment.

The bearing structure of the present invention is also preferable to be configured in that, for example, the opposing surfaces of right cup 6 fixed on hanger lag 3a of hanger section 3 and receiving ring 8c of bearing portion 8 are nearly spherically shaped.

Also, even if the machining accuracy of hanger lag 3a is high, distortion is always generated when each part of frame body 2 is welded, and even in such a case, using a bearing structure of the present invention, it is possible to obtain an action and effect almost equivalent to the above embodiment.

The bearing structure of the present invention is, for example, also usable for bearing a hub shaft fitted on adjacent hubs, a pedal shaft on which a pedal body is fitted, or a rotary shaft of a machine or mechanism.

1. An elastomeric spring assembly for a railcar, said spring assembly comprising:
an elongated body of elastomer which is permanently deformed as a result of precompression of a preform having a precompressed height, said elongated and permanently deformed elastomer body defining an elongated axis and axially spaced ends for said spring assembly; and
a series of axially spaced members coaxially and centrally arranged and wholly embedded within said permanently deformed elastomer body, with each member being configured to resist radial outward movement of said elastomer body relative to said axis while causing said elastomer to react in an axial direction between confronting surfaces defined by said members upon axial deflection of said elastomeric spring assembly whereby said spring assembly has a repeatable force/deflection curve following precompression of said elastomer body, and with said repeatable force/deflection curve having a substantially increasing rate which persists between initial columnar deflection and about 90% columnar deflection of said spring assembly, and wherein said permanently deformed elastomer body has an outer surface with generally evenly spaced radially bulging permanent ridges formed thereon without any columnar loading being applied to the ends of the elastomer body such that said spring assembly has an operational height ranging between about 80% to about 85% of the precompressed height of said preform and before being arranged in operable combination with said railcar.

2. The spring assembly according to claim 1 wherein the elastomer forming said elongated body has a plastic to elastic strain ratio greater than 1.5 to 1.

3. The spring assembly according to claim 1 wherein each member is bonded to the elastomer forming said elongated body.

4. The spring assembly according to claim 1 wherein said series of members embedded within said elongated elastomer body comprise helical convolutions of a coil spring.

5. (canceled)

6. A railcar car apparatus for absorbing, dissipating and returning energy imparted thereto, said apparatus comprising:
a housing; and
a spring assembly adapted to be mounted within a cavity defined by said housing, said spring assembly having an elongated body of elastomer which is permanently deformed as a result of precompression of a preform having a precompressed height, with said permanently deformed elastomer body defining an elongated axis and having an inner closed marginal edge, an outer marginal edge with permanently formed radially bulging and generally even spaced permanent ridges formed thereon with no columnar loading being applied to axially spaced first and second ends of said elastomer body, and a series of axially spaced members arranged generally coaxial relative to said elongated and permanently deformed elastomer body, with each member being centralized between the inner closed marginal edge and said outer marginal edge of said permanently deformed elastomer body, and wherein said members resist radial outward movement of the elastomer body while causing elastomer between confronting surfaces of said members to axially react in an axial direction upon axial deflection of said spring assembly whereby providing said spring assembly with a repeatable force/deflection curve following precompression of said preform, and with said repeatable force/deflection curve having a substantially increasing rate which persists between initial columnar deflection and about 90% columnar deflection of said spring assembly, and wherein the radially bulging ridges on said permanently deformed elastomer body provide said spring assembly with an operational height ranging between about 80% and about 85% of the precompressed height of said preform and before said spring assembly is arranged in operable combination with said railcar apparatus.

7. The railcar apparatus according to claim 6 wherein said elongated elastomer body is formed from an elastomer having a plastic to elastic strain ratio greater than 1.5 to 1.

8. The railcar apparatus according to claim 6 wherein a majority of members embedded within said elongated elastomer body are mechanically bonded to said elastomer body.

9. The railcar apparatus according to claim 6 wherein the inner closed marginal edge of said elongated elastomer body is sized to slidably accommodate while fitting about and along a generally centralized guide provided on said housing.

10. (canceled)

11. An elastomeric spring assembly for a railroad car apparatus, said elastomeric spring assembly comprising:
an elongated tubular member of elastomer which is permanently deformed as a result of precompression of a preform having a precompressed height, said tubular and permanently deformed elastomer member having an inner closed marginal edge and an outer marginal edge along with axially spaced first and second ends defining the operational length of said member;
a coil spring arranged generally coaxial relative to extending substantially the length of said elastomer member and including a series of helical convolutions, with each convolution of said spring being centralized between the inner closed marginal edge and said outer marginal edge of said permanently deformed elastomer member such that the inner radial surface of the majority of said helical convolutions on said coil spring restrict radial outward movements of the elastomer encompassed thereby while confronting axially spaced surfaces on said helical convolutions allow said elastomer to react in an axial direction whereby providing said spring assembly with a repeatable force/deflection curve following precompression of said preform, and with said repeatable force/deflection curve having a substantially increasing rate which persists between initial columnar deflection and about 90% columnar deflection of said spring assembly, and wherein said permanently deformed elastomer member has an outer surface with generally evenly spaced radially bulging permanent ridges formed thereon without any columnar loading being applied to the ends of the elastomer member such that the operational height of said permanently defamed deformed elastomer member ranges between about 80% and about 85% of the precompressed height of said preform and before said spring assembly is arranged in operable combination with said railcar apparatus.

12. The elastomeric spring assembly according to claim 11 wherein the elastomer from which said tubular member is formed is mechanically joined to said coil spring.

13. The elastomeric spring assembly according to claim 11 wherein the elastomer from which said tubular member is formed is selected from a class of elastomers having a plastic to elastic strain ratio greater than 1.5 to 1.

14. (canceled)

15. A method of manufacturing an elastomeric spring assembly defining an elongated axis, said method comprising the steps of:
encapsulating a series of axially spaced members in an elongated body formed from an elastomeric material to create a preform having opposed ends, with each member being generally centralized between inner and outer surfaces on said elongated body, with the majority of said members being configured to resist radial outward movement of said elastomeric material relative to said axis while causing said elastomeric material to react in an axial direction between confronting surfaces defined by said members upon axial deflection of said elongated body, and wherein said preform has a precompressed height between said opposed ends; and
compressing said preform by an amount exceeding 15% of the precompressed height of said preform whereby causing permanent deformation of and transmuting said elastomeric body and members into an elastomeric spring assembly having a repeatable force/deflection curve following precompression of said elongated body, and with said repeatable force/deflection curve having a substantially increasing rate which persists between initial columnar deflection and about 90% columnar deflection of said spring assembly, with said permanently deformed elastomeric body of said spring assembly having an outer surface with generally evenly spaced, radially bulging permanent ridges formed thereon without any columnar loading being applied to the opposed ends of the elastomeric body such that an operational height of said spring assembly ranges between about 80% to about 85% of the precompressed height of said preform and before said spring assembly is arranged in operable combination with said railcar apparatus.

16. The method for making an elastomeric spring assembly according to claim 15 further including the step of: treating an exterior surface of each member to inhibit said elastomeric body encapsulating said members from moving therepast.

17. The method for making an elastomeric spring assembly according to claim 15 further including the step of: providing a central bore in the elastomeric body which opens at opposite ends.

18. The method for making an elastomeric spring assembly according to claim 17 wherein said members embedded within said elongated body are comprised of helical convolutions on a coil spring.

19. (canceled)
